(19) United States
(12) Patent Application Publication
(10) Pub. No.: US 2014/0251442 A1
(43) Pub. Date: Sep. 11, 2014

(54) DEVICE AND METHOD FOR REDUCING THE PRESSURE OF A FLUID CONTAINING GRANULES

(71) Applicant: AUTOMATIK PLASTICS MACHINERY CMBH, Grossostheim (DE)

(72) Inventors: Stefan Dahlheimer, Kleinostheim (DE); Helmuth Meidhof, Grossostheim (DE); Stefan Deiss, Harxheim (DE)

(73) Assignee: AUTOMATIK PLASTICS MACHINERY GMBH, Grossostheim (DE)

(21) Appl. No.: 14/283,207

(22) Filed: May 20, 2014

Related U.S. Application Data
(63) Continuation of application No. PCT/EP2012/004752, filed on Nov. 15, 2012.

(30) Foreign Application Priority Data
Nov. 21, 2011 (DE) 102011119076.0

(51) Int. Cl. F15D 1/00

(52) U.S. Cl. CPC F15D 1/0015
USPC 137/14; 138/42

(57) ABSTRACT

A device and a method for reducing the pressure of a fluid containing granules. The device comprises a free space devoid of moving rotor blades and a housing with an inlet and an outlet. The shape of the wall within the housing and of the free space therein applies a centripetal flow component to the fluid containing the granules flowing therethrough. The pressure of the fluid containing the granules is decreased after the flow has passed through the device. The device and method further and impart a rotational motion to the fluid containing the granules in the area of the outlet, which is generally located in the central area of the free space.

### CROSS REFERENCE TO RELATED APPLICATIONS

The present patent application is a Continuation Application that claims priority to and the benefit of co-pending International Patent Application No. PCT/EP2012/004752, filed Nov. 15, 2012, entitled “DEVICE AND METHOD FOR REDUCING THE PRESSURE OF A FLUID CONTAINING GRANULES”, which claims priority to DE Application No. 102011119076.0 filed Nov. 21, 2011, entitled “DEVICE AND METHOD FOR REDUCING THE PRESSURE OF A FLUID CONTAINING GRANULES”. These references are incorporated in their entirety herein.

### FIELD

The present embodiments generally relate to a device for reducing the pressure of a fluid containing granules.

### BACKGROUND

Generally speaking, granules, for example granules of polymer material comprising volatile constituents, are produced in underwater granulators. During this process, a melt of material to be granulated is pressed by means of an extruder or a melt pump through nozzle apertures of a perforated plate into process fluid in a process chamber of an underwater granulator.

The melt material can be cut into individual granules by a rotating cutter assembly. These granules are often carried away from the process chamber in a process fluid circuit and delivered for further processing. In the granulation of polymer material having effervescent constituents such as polystyrene, or of polymer material made using polymer melts containing foaming agents, the process fluid can be delivered under pressure to a process chamber via a process fluid circuit. In this instance, the process fluid with the granules contained therein must be depressurized afterwards.

Therefore, it is necessary for pressure reduction of the process fluid with the granules contained therein to take place in corresponding underwater granulators before the granules are separated from the process fluid and further processed. The process fluid can be returned to the process chamber. Examples of underwater granulators are known under the product name SPHERO® from the firm Automatik Plastics Machinery GmbH.

To reduce the pressure of the process fluid with the granules contained therein, a device such as an impeller lock can be used. An impeller lock can have a housing with an inlet and an outlet, wherein an impeller wheel that is set in rotational motion by a motor via a shaft is provided in the housing, so that the pressure of the fluid with the granules contained therein decreases after flowing through the device. Additionally, a rotational motion is imposed on the fluid with the granules contained therein by the impeller lock in the general region of the outlet.

The use of such impeller locks is very effective for the task of decreasing pressure. Nevertheless, when such impeller locks are used the problem can arise, such as with granulation of melt materials that tend to stick together. For example, granules made of polyamide 6 can adhere in the region of the impeller locks, and in severe cases the agglomerated granules can clog the impeller locks or even plug the impeller locks up entirely.

There are various options for reducing the pressure of process fluid in granulation processes known in the industry.

Prior art describes a granulating device in which an energy converter is used to reduce the pressure of the process fluid with the granules contained therein, wherein the converter can be a turbine with turbine rotor or a gear pump with reversed direction of energy flow and gears running therein. The converter can also be a corresponding impeller lock.

Consequently, the object of the present invention is to provide a device and a method for reducing the pressure of a fluid containing granules that overcome(s) the disadvantages of the prior art. It is a further object of the invention to reduce the pressure of a fluid containing granules in a structurally simple manner while minimizing disruption of process flow due to clogging with granules or granule agglomerates.

The present embodiments meet these needs.

### BRIEF DESCRIPTION OF THE DRAWINGS

The detailed description will be better understood in conjunction with the accompanying drawings as follows:

FIG. 1 is a perspective view of a device for reducing the pressure of a fluid containing granules.

FIG. 2 is a sectional top view of the device for reducing the pressure of a fluid containing granules.

FIG. 3 is a sectional side view of the device for reducing the pressure of a fluid containing granules.

FIG. 4 is a sectional side view of the device for reducing the pressure of a fluid containing granules.

FIG. 5 is a sectional top view of the device for reducing the pressure of a fluid containing granules.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The device for reducing the pressure of a fluid containing granules can have a housing with an inlet and an outlet. Within the housing is a free space remaining clear of rotating rotor blades. The free space has a side wall with a circumferential shape that is designed in top view such that a centripetal flow component is imposed by it on the fluid with granules contained therein when the fluid flows therethrough. The pressure of the fluid with the granules contained therein decreases after flowing through the device, and a rotational motion is imposed on the fluid with the granules contained therein in the vicinity of the single outlet arranged in the central region of the free space.

In the device, the side wall and the corresponding circumferential shape of the housing or of the free space can be designed for a centripetal flow component to be imposed on fluid and the granules contained therein. This centripetal flow component can be caused by the specific side wall shape or the specific side wall contour such that dissipative effects in the fluid cause the pressure to be reduced as a result.

This means that the flow of fluid in the device is essentially in the shape of a spiral (or else is helical, as explained further below) and proceeds from the edge of the housing or of the free space toward the center, where an outlet is disposed.

In this embodiment, a space in the housing is kept clear as a free space, in particular no impeller lock is furnished. Instead, for the desired pressure reduction it is sufficient to merely provide a housing shape that can essentially resemble an impeller lock housing.

Hence, flow in a plane of the housing can be imposed in a spiral shape proceeding from the outside to the outside. A three-dimensional character of the flow in the housing (with an additional component perpendicular (axial) to the actual radial extent of the free space) is likewise possible. However, it is also possible to provide a constant, preferably relatively small, height of the free space there by means of the diameter, i.e. the radial extent of the housing or of the free space located therein.

The single outlet can be arranged to be perpendicular to the inlet. As a result, the fluid with the granules contained therein can be removed reliably and effectively from the center of the free space in the region there.

The device can be designed or spatially arranged such that the spiral-shaped motion in the housing or in the free space takes place in the horizontal plane, and the fluid with the granules contained therein discharges downward, or vertically, under the influence of gravity, and the housing with inlet is arranged horizontally, and the outlet accordingly can be arranged vertically.

The side wall can have a wall region that in top view is at least partially spiral-shaped in design, such as in the region of the inlet. The regions that in top view are spiral-shaped in design or the spiral-shaped wall region can result in favorable hydrodynamics, causing turbulence in the housing or in the free space to be avoided. This can further contribute to the avoidance of granule accumulation and formation of agglomerates.

The inlet to the housing and to the free space therein can be tangential and terminate in the side wall. The inlet can widen toward the housing and toward the free space in a conical manner.

In embodiments, the tangential and/or widening character of the inlet toward the housing creates a hydrodynamically favorable arrangement, which can prevent clogging by granules. The single outlet can be arranged in the central region of the free space in one of the top/bottom walls of the housing and of the free space.

The side wall can be tapering in a side view, and conically or parabolically tapering in embodiments. The single outlet can be arranged adjacent to the tapering region. Thus, if a three-dimensional flow is desired, the tapering section of the side wall can be designed such that the flow, which otherwise would proceed essentially in a spiral shape in one plane, is additionally made helical toward the outlet effectively in three dimensions.

The downward motion can be induced using the influence of gravity, in combination with the shape of the side wall, which additionally increases the dwell time of the fluid within the free space and the opportunity for pressure reduction. In addition, the tendency of the granules in the fluid to clump can be efficaciously reduced by the corresponding increase in volume of the free space thus formed.

The outlet leading away from the housing and from the free space can narrow and, in embodiments, narrow in a conical manner. The conical design of the outlet can offer hydrodynamic advantages preventing the agglomeration of granules in the region of the outlet.

In embodiments, an outlet that widens that widens conically, leading away from the housing and from the free space can also be implemented, wherein an additional reduction in the pressure of the fluid with the granules contained therein is possible. The additional pressure reduction can be due to the widening following an appropriate constriction placed at the transition from the housing or free space to the outlet. A suction effect can also be achieved in this way, which can additionally counteract the clumping tendency of granules in the fluid.

In accordance with another embodiment of the device, a pinch valve can be arranged in the region of the outlet with which the flow rate and a corresponding back pressure can be adjusted to provide for additional pressure reduction.

In addition to the hydrodynamic design of the device as already described, the pressure reduction can additionally be adjustable, at least to a certain extent, as a function of operating conditions which can be controlled. For example pressure reduction can be adjusted by varying the throughput rate of fluid with granules contained therein, the melt material used to make the granules, or the required process pressure during the granulation process.

Guide vanes can be arranged in the region adjacent to the side wall in the housing and in the free space such that a centripetal flow component applied to the fluid with the granules contained therein is intensified. In embodiments, the guide vanes are can be adjustable in their angle of incidence, are designed to be rotatable, or combinations thereof.

The guide vanes can be continuously adjusted, for example by electric drives. However, this design is not an impeller lock wheel according to the prior art, which of course would be rotatably mounted in the housing of an impeller lock. Rather, the guide vanes serve merely to apply a corresponding centripetal motion component, which can be applied and intensified in the edge region of the free space where the guide vanes can be arranged.

The device can have a spiral wall running inward from the inlet in a spiral shape (as viewed from above) which can be arranged in the housing and in the free space. The spiral wall in this embodiment can be arranged only in the region of the inlet and in the region adjacent to the side wall in the housing and in the free space, or can be arranged to extend into the region of the outlet (in a spiral winding or in multiple closed spiral windings).

In embodiments, the spiral wall can be removable from the housing and the free space, or attached to one of the top and bottom walls. Thus, effective flow guidance can be achieved without rotating parts or rotor blades in the housing or in the free space. Pressure of the fluid can be further reduced due to the additional wall friction with the same basic housing shape.

In embodiments, at least one of the top or bottom walls of the housing can be attached removably. The top and bottom walls of the housing can be attached with a suitable fastener in conjunction with a flange section extending around the circumference of the housing.

In embodiments, a clamp connection from the top/bottom wall to the rest of the housing can also be used, such as a clamping jaw acting circumferentially. A removable top or bottom wall of the housing provides access to the housing and to the free space for cleaning or maintenance activities, for example to remove deposits formed during operation. Cleaning or maintenance activities are greatly simplified and accelerated since there is no need to remove rotating parts such as an impeller lock wheel during this process.

In the method for reducing the pressure of a fluid containing granules, in a housing with an inlet and an outlet, a free space remaining clear of moving rotor blades is provided, wherein a centripetal flow component is imposed there on the fluid with granules contained therein by the shape of the walls of the housing and of the free space when the fluid flows therethrough. The pressure of the fluid with the granules contained therein decreases as a result of flowing through the device, during which a rotational motion is imposed on the fluid with the granules contained therein in the vicinity of the outlet.

In other respects, the statements made regarding the device also apply with regard to the corresponding embodiments of the method.

The invention is explained in detail below using the attached figures by way of example.

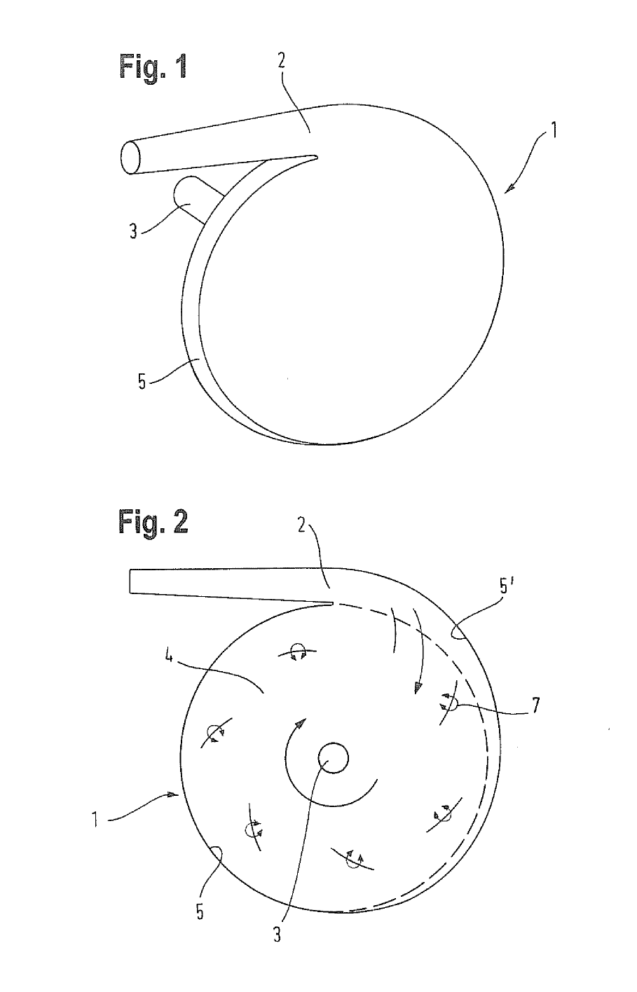

FIG. 1 is a perspective view of a device for reducing the pressure of a fluid containing granules.

The device according to the invention serves to reduce the pressure of a fluid containing granules. The device is generally shaped similarly to an impeller lock and has a housing 1 with an inlet 2 and an outlet 3.

In this embodiment, the inlet 2 is arranged on the side of the housing 1 to deliver the fluid containing the granules tangentially to the interior of the housing 1 to an internal free space (not visible in FIG. 1). The device does not use an impeller lock wheel, in contrast to the prior art. A rotational motion is imposed on the fluid with the granules contained therein simply by flowing through the inlet 2 into the interior of the housing 1.

The fluid containing the granules flows through the free space and from there), under the influence of and maintaining the imposed rotational motion, to the outlet 3, where it flows out. In this process, the pressure of the fluid containing the granules is reduced in the region of the outlet 3 of the housing 1 in comparison with the pressure at the inlet 2 as a result of the flow through the device. The outlet 3 can be rotationally symmetric when viewed from above.

As a basic principle, like reference symbols in the figures designate like elements of the device according to the invention, wherein the particular explanations apply in each case to all figures, and the elements shown also can each be combined with one another in various combinations, even when this is not always explicitly shown in the figures.

FIG. 2 shows a sectional top view of the device for reducing the pressure of a fluid containing granules.

FIG. 2 shows guide vanes 7 provided in the edge region of the free space 4. The guide vanes can be adjustable in their angle of incidence, as is indicated by corresponding arrows. The imposed direction of motion of the fluid with the granules contained therein is likewise made evident by arrows. In this embodiment, the free space 4 in the housing 1 is rotationally symmetric as indicated by dashed lines, wherein the dashes also make the inward spiraling wall 5 in the vicinity of the wall region 5′ more clearly discernible.

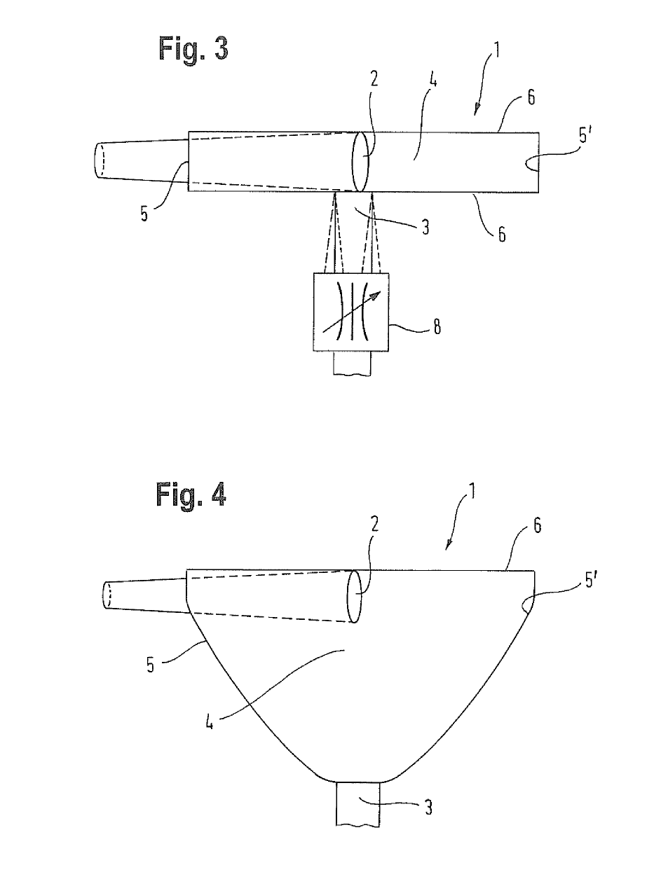

FIG. 3 shows a sectional side view of the device for reducing the pressure of a fluid containing granules.

FIG. 3 shows a relative positioning of the inlet 2 and the outlet 3 at right angles to one another, wherein the outlet 3 is centrally located in a bottom wall 6. A top wall 6 as shown in FIG. 3 can be removably attached, for example by fasteners (not explicitly shown in the figures). The expanding progression of the inlet 2 toward the housing and toward the free space 4 is also evident. The outlet 3 can narrow or widen, as is indicated by the shapes of the outlet 3 shown in dashed lines. Also shown is a throttle valve or pinch valve 8, which can additionally be provided in the vicinity of the outlet 3.

FIG. 4 shows a sectional side view of the device for reducing the pressure of a fluid containing granules.

In this embodiment, it is additionally possible to impose a three-dimensional helical flow on the fluid containing the granules by the wall region 5′, which tapers in a conical or parabolic manner as shown.

In the device, the load ratio, which is to say the ratio between the fluid and the granules contained therein, can preferably be below 10 percent by weight. This means that 10 percent by weight of the mixture of fluid and granules consists of granules. Clumping of granules and formation of agglomerates will be prevented efficaciously when the corresponding method according to the invention is used with the device.

Moreover, the funnel-shaped designs of the inlet and outlet also serve to utilize a Venturi effect for pressure reduction of the fluid.

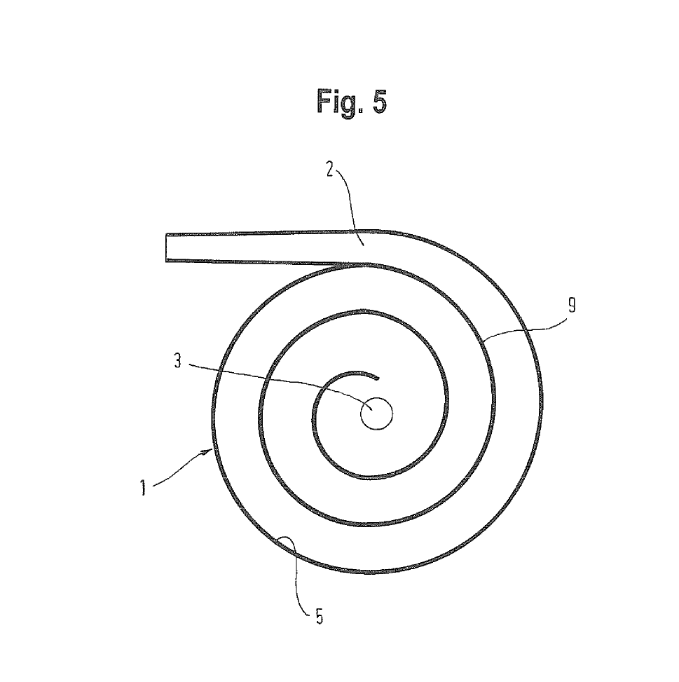

FIG. 5 shows a sectional top view of the device for reducing the pressure of a fluid containing granules.

The embodiment of the invention shown in FIG. 5 includes a spiral wall 9 running inward from the inlet in a spiral shape as viewed from above arranged in the interior of the housing or of the free space 4. In this embodiment, the spiral wall 9 extends in multiple closed spiral windings. Other embodiments in which the spiral wall 9 is located essentially only in the region of the inlet and in the region adjacent to the side wall in the housing and in the free space and/or has only one spiral winding are possible.

The spiral wall 9 can be removable from the housing and the free space, and can be attached to one of the top/bottom walls, or can be an integral part of the corresponding top or bottom wall.

While these embodiments have been described with emphasis on the embodiments, it should be understood that within the scope of the appended claims, the embodiments might be practiced other than as specifically described herein.

What is claimed is:

1. A device for reducing the pressure of a fluid containing granules comprising: a housing with a top wall, a bottom wall, an inlet, and an outlet, wherein the housing comprises a free space and a side wall with a circumferential shape for imposing a centripetal flow component on a fluid flowing therethrough, such that the pressure of the fluid decreases after flowing through the device, and such that a rotational motion is imposed on the fluid in the vicinity of the outlet.

2. The device of claim 1, further comprising at least one of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

3. The device of claim 1, further comprising at least two of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

4. The device of claim 1, further comprising at least three of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

5. The device of claim 1, further comprising at least four of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

6. The device of claim 1, further comprising at least five of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

7. The device of claim 1, further comprising at least six of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

8. The device of claim 1, further comprising at least seven of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

9. The device of claim 1, further comprising at least eight of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

10. The device of claim 1, further comprising at least nine of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

11. The device of claim 1, further comprising at least ten of the following:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing;
g. a widening of the cross section of the outlet as it extends from the housing;
h. a pinch valve disposed adjacent to the outlet;
i. a plurality of guide vanes arranged in adjacent to the side wall such that the centripetal flow component is intensified, and wherein the guide vanes are, fixed, adjustable in their angle of incidence, or rotatable;
j. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
k. a means of removably attaching at least one of the top wall or bottom wall.

12. The device of claim 1, further comprising:
a. a wall region in the side wall that is spiral-shaped in the region of the inlet;
b. a tangential shape of the inlet, wherein the tangential shape terminates in the side wall;
c. a conical widening of the inlet in the direction of the free space;
d. a central region in one of the top wall or the bottom wall to locate the outlet;
e. a taper in the side wall adjacent to the outlet;
f. a narrowing of the cross section of the outlet as it extends from the housing or a widening of the cross section of the outlet as it extends from the housing;
g. a pinch valve disposed adjacent to the outlet;
h. a plurality of guide vanes arranged in adjacent to the side wall such that the centripetal flow component is intensified, and wherein the guide vanes are, fixed, adjustable in their angle of incidence, or rotatable;
i. a spiral wall disposed in the housing and in the free space adjacent the inlet, wherein the spiral wall at least partially extends toward the outlet, and further wherein the spiral wall is fixed within the housing, removable from the housing, or attached to the top wall or the bottom wall; and
j. a means of removably attaching at least one of the top wall or bottom wall.

13. A method for reducing the pressure of a fluid containing granules, comprising:
a. providing a housing comprising an inlet, an outlet, at least one wall, and a free space;
b. flowing a fluid through the housing;
c. imposing a centripetal flow component on the fluid with a curved shape of the at least one wall when the fluid flows therethrough; and
d. imposing a rotational motion on the fluid in the vicinity of the outlet; and thereby decreasing the pressure of the fluid.
